(19) United States
(12) Patent Application Publication
(10) Pub. No.: US 2009/0179887 A1
(43) Pub. Date: Jul. 16, 2009

(54) Digital photo frame with a power saving function and a power saving method thereof

(76) Inventors: Chi-Tung Chang, Taipei (TW); Jar-Haw Lee, Taipei (TW); Chuan-Ching Tsai, Taipei (TW); Meng-Huang Chu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,718

(22) Filed: Mar. 10, 2008

(30) Foreign Application Priority Data
Jan. 16, 2008 (TW) 97101654

(51) Int. Cl. G09G 5/00

(52) U.S. Cl. 345/212

(57) ABSTRACT

A digital photo frame with a power saving function includes a time-counting unit, a sensing unit, a displaying unit, and a processing unit. The time-counting unit is used for generating a time-counting signal. The sensing unit is used for sensing the environmental status and generating a sensing signal. The displaying unit is used for displaying an image data. The processing unit controls the sensing unit and the displaying unit. The processing unit further uses a power control unit to control the power supply according to the time-counting signal and the sensing signal so that the digital photo frame operates in a normal mode. After the processing unit does not receive the sensing signal within a pre-determined period counted by the time-counting signal, the processing unit controls the power supply so that the digital photo frame operates in a power saving mode. Hereby, the goal of power saving is achieved.

### BACKGROUND OF THE INVENTION

1. Field of the Invention

The present invention relates to a digital photo frame. In particular, this invention relates to a digital photo frame with a power saving function and a power saving method.

2. Description of the Related Art

As the digital still camera has been well developed, the users can easily store their daily memory in digital photos. Therefore, the digital photo frames for displaying the digital photos become popular, and has a trend to replace the traditional photo frame. Because the dimensions of the digital photo frame are small and its appearance is exquisite, the digital photo frames are applied to a variety of locations, such as office or the home, for displaying the photos.

However, the digital photo frame needs an external power (such as a household power source or a power supply of the computer) for operating, and the display screen of the digital photo frame is power-consuming. When the digital photo frame displays the digital photos for a long time, it cannot meet the environmental protection requirement of being power-saving. So the user does not wish to always turn on the digital photo frame for displaying the digital photos. Therefore, the fun of the digital photo frame is substantially reduced, and it is inconvenient for the user to display the digital photos on the digital photo frame.

How to improve the power supply of the digital photo frame to reduce the required power for the digital photo frame is an issue.

### SUMMARY OF THE INVENTION

In order to meet the main function of the digital photo frame, displaying the digital photo to the users, the digital photo frame of the present invention has a sensing unit for sensing the environmental status of the digital photo frame to determine whether someone is around the digital photo frame. When someone is near to the digital photo frame, the digital photo frame is normally operated to display the photos. When nobody is near to the digital photo frame, the digital photo frame enters the power-saving mode. Thereby, the digital photo frame has the power saving function, without modifying the complex power circuit.

One particular aspect of the present invention is to provide a digital photo frame with a power saving function. The digital photo frame with a power saving function includes a time-counting unit, a sensing unit, a displaying unit and a processing unit. The time-counting unit is used for generating a time-counting signal. The sensing unit is used for sensing the environmental status and generating a sensing signal. The displaying unit is used for displaying image data. The processing unit controls the sensing unit to perform the sensing operation and controls the displaying unit to display the image data. The processing unit uses a power control unit to control the power supply according to the time-counting signal and the sensing signal so that the digital photo frame operates in a normal operation mode. After the processing unit does not receive the sensing signal within a pre-determined time-counting period, the processing unit controls the power supply so that the digital photo frame operates in a power saving mode.

A power saving method for a digital photo frame is disclosed. The method includes the following steps. First, after the digital photo frame is turned on, a time-counting signal is reset and the time is counted. Next, a sensing unit is provided to sense the environmental status. The power supply is controlled so that the digital photo frame enters in a power saving mode when the sensing unit does not generating a sensing signal within a pre-determined period counted by the time-counting signal. Furthermore, by repeating the sensing step and the determining step until a sensing signal is generated in the sensing step, the power supply is controlled so that the digital photo frame enters in a normal operation mode.

The characteristic of the present invention is that the power saving effect can be easily achieved, without modifying the complex power circuit, studying the total power consumption, and affecting the operation mode of the user for the digital photo frame.

For further understanding of the invention, reference is made to the following detailed description illustrating the embodiments and examples of the invention. The description is for illustrative purpose only and is not intended to limit the scope of the claim.

### BRIEF DESCRIPTION OF THE DRAWINGS

The drawings included herein provide a further understanding of the invention. A brief introduction of the drawings is as follows:

FIG. 1 is a block diagram of the digital photo frame with a power saving function of the present invention;

FIG. 2 is a flow chart of the power saving method for a digital photo frame of the present invention;

FIG. 3 is a flow chart of the digital photo frame with a power saving function operated in a power saving mode of the present invention; and

FIG. 4 is a schematic diagram of an application embodiment of the digital photo frame with a power saving function of the present invention.

### DETAILED DESCRIPTION OF THE PREFERRED EMBODIMENTS

The digital photo frame of the present invention can automatically judge whether someone is around the digital photo frame or not to determine its operation mode. When nobody uses the digital photo frame or is near to the digital photo frame, the digital photo frame is controlled to be operated in a power saving mode to achieve the power saving effect.

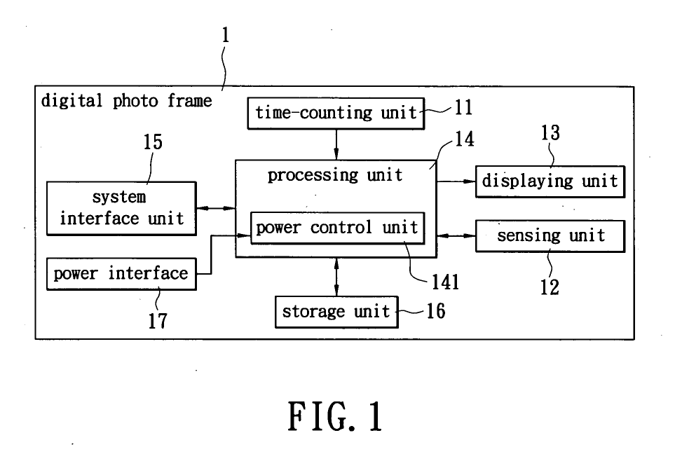

Reference is made to FIG. 1, which shows a block diagram of the digital photo frame with a power saving function of the present invention. As shown in FIG. 1, the digital photo frame 1 with a power saving function includes a time-counting unit 11, a sensing unit 12, a displaying unit 13, a processing unit 14, a system interface unit 15, a storage unit 16, and a power interface 17. The time-counting unit 11 is used for generating a time-counting signal, and the sensing unit 12 is used for sensing the environmental status and generating a sensing signal.

The sensing unit 12 can be an IR sensor (such as a human body IR sensor), or an image sensor. When the sensing unit 12 is an IR sensor, it detects the environmental status change around the digital photo frame 1 and generates a trigging signal (for example, when someone is approaching the digital photo frame 1, the human body IR sensor detects the environmental status change to generate a trigging signal) to generate a sensing signal. When the sensing unit 12 is an image sensor, an image signal of the environmental status around the digital photo frame 1 is obtained and the sensing unit 12 performs an image calculation to the image signal to determine the image signal is a human body signal. This means that the environmental status around the digital photo frame 1 changes, and the sensing signal is outputted. Furthermore, the environment status change depends on the sensor.

The displaying unit 13, such as an LCD, is used for displaying image data. The storage unit 16 is used for storing the image data that will be displayed by the user and is accessed by the processing unit 14. The storage unit 16 can be a non-volatile memory (such as a flash memory), a memory card or a combination thereof.

The processing unit 14 is connected with the time-counting unit 11, the sensing unit 12, the displaying unit 13 and the storage unit 16. In additional to receiving the time-counting signal generated by the time-counting unit 12, the processing unit 14 also controls the sensing unit 12 to detect the environmental status and controls the displaying unit 13 to display the image data after the processing unit 14 accesses the image data in the storage unit 16.

Moreover, the processing unit 14 further uses a power control unit 141 to control the power supply for the all units in the digital photo frame 1 according to the time-counting signal and the sensing signal. When someone is near to the digital photo frame 1 and the sensing unit 12 detects this status, the processing unit 14 receives the sensing signal to control the digital photo frame 1 to be operated in a normal operation mode. This means that the image data is displaying. On the contrary, when the processing unit 14 does not receive the sensing signal within a pre-determined period counted by the time-counting signal, it means that the sensing unit 12 does not detects the environmental status change. The processing unit 14 controls the power supply via the power control unit 141 so that the digital photo frame 1 is operated in a power saving mode. For example, the pre-determined period can be 5 minutes. When the sensing unit 12 does not generate the sensing signal within 5 minutes, the processing unit 14 controls the digital photo frame 1 to be operated in a power saving mode. The pre-determined period can be set when the digital photo frame 1 is produced or can be set by the user.

In this embodiment, in order to illustrate the present invention, the power control unit 141 is built-in the processing unit 14 and is used for controlling the power supply by the processing unit 14, as shown in FIG. 1. However, the power control unit 141 also can be connected with the processing unit 14 by an external connection way, and receives the control from the processing unit 14 to manage the power supply.

When the digital photo frame 1 is operated in the power saving mode, the power supply controlled by the processing unit 14 can be implemented by the following ways. Because the LCD is the most power-consuming part in the digital photo frame 1, the simple way is to turn off the power supply for the displaying unit 13. The other units, such as the sensing unit 12, the processing unit 14, still are in the normal operation mode. Therefore, when the sensing unit 14 detects the environmental status change, the sensing unit 14 generates the sensing signal to the processing unit 14 so that the processing unit 14 controls the power supply for the displaying unit 13 to be turned on and is operated in a normal operation mode.

The second way can save more power than the first way. When the digital photo frame 1 is operated in the power saving mode, the processing unit 14 is also turned off. Because the sensing unit 12, the displaying unit 13 and the storage unit 16 are controlled by the processing unit 14, the power supply for the sensing unit 12, the displaying unit 13 and the storage unit 16 are also turned off when the processing unit 14 is turned off. Therefore, in addition to turn off the power supply for the displaying unit 13, the other related units are also turned off so that more power is saved.

For the second power saving way, the time-counting unit 11 is an independent unit, and can be operated in a low power status. Therefore, the time-counting unit generates an enable signal to the processing unit 14 per a pre-determined period (such as 2 seconds) to turn on or wake up the processing unit 14. Thereby, the processing unit 14 can re-supply the power to the sensing unit 12 for-detecting the environmental status. Of course, when the sensing unit 12 still does not detect the environmental status change, the processing unit 14 enters the turned-off status again due to the time counted by the time-counting signal is greater than the pre-determined period. The above steps are repeated until the sensing unit 12 detects the environmental status change and generates the sensing signal to the processing unit 14 to display the image data.

Moreover, the system interface unit 15 of the digital photo frame 1 is connected with the processing unit 14 and is used for connecting an application system (such as a computer, not shown in the figure), and transmitting signal between the digital photo frame 1 and the application system. The power interface 17 is used for receiving the household power and converting the power to supply to the power supply unit 141 and be used as the power source of the digital photo frame 1. Of course, in addition to supply the household power to the digital photo frame 1, the digital photo frame 1 can receive the power from the application system via the system interface unit 15 when the digital photo frame 1 is merely connected with the application system via the system interface unit 15. For example, when the system interface unit 15 is the universal serial bus (USB), the digital photo frame 1 receives the 5 volts power from the application system when the digital photo frame 1 is connected with the application system.

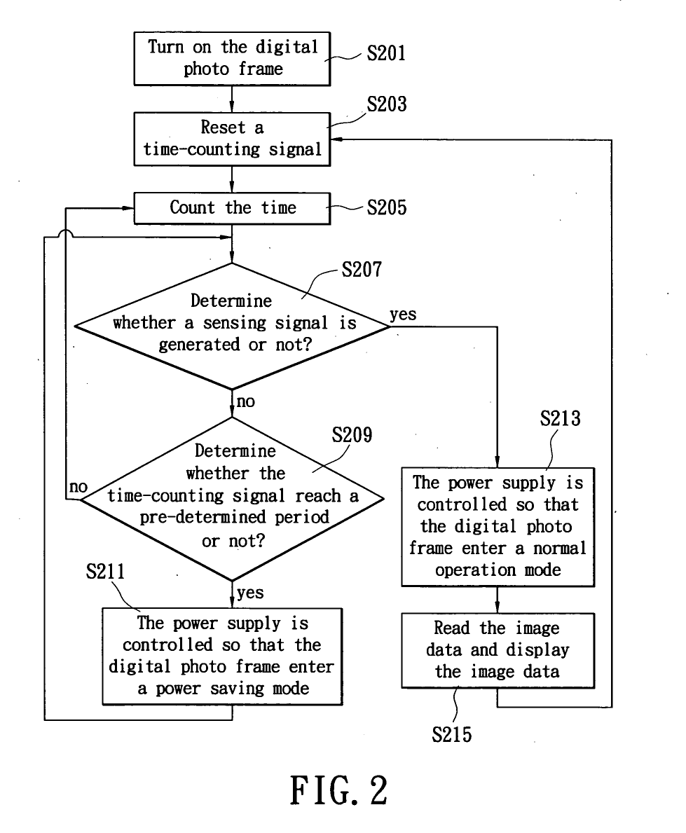

In order to clearly illustrate the present invention, reference is made to FIG. 2. FIG. 2 is the flow chart of the power saving method for a digital photo frame of the present invention. The power saving method for a digital photo frame 1 includes the following steps. First, the digital photo frame 1 is turned on (S201), and a time-counting signal is reset (S203). After the time-counting signal is reset (that means the counted time is set to zero), the time is counted (S205).

Next, a sensing unit 12 is provided to sense the environmental status to judge whether the environmental status changes and generate a sensing signal (S207). When the result of the step S207 is negative, this means that the environmental status around the digital photo frame 1 has not changed. This also means that nobody is near the sensing unit 12. Therefore, no sensing signal is generated, and whether the counting signal reaches a pre-determined time is checked (S209).

If the checking result of step S209 is negative, the step S205 is repeated to continuously count the time, and the flowing steps are performed. If the checking result of step S209 is positive, it means that the predetermined period is reached, and nobody is close to the digital photo frame 1 so that the sensing unit 12 does not generate the sensing signal. Therefore, the power supply is controlled so that the digital photo frame 1 is operated in the power saving mode (S211). After the digital photo frame 1 is operated in the power saving mode, the sensing unit 12 executes the step S207 to determine whether a sensing signal is generated or not.

If the result of step S207 is yes, it means that the sensing unit 12 detects the condition of someone being around the digital photo frame 1 and generates the sensing signal. Therefore, the power supply is controlled so that the digital photo frame 1 is operated in a normal operation mode (S213). At this time, the digital photo frame 1 reads the image data and displays the image data to the user.

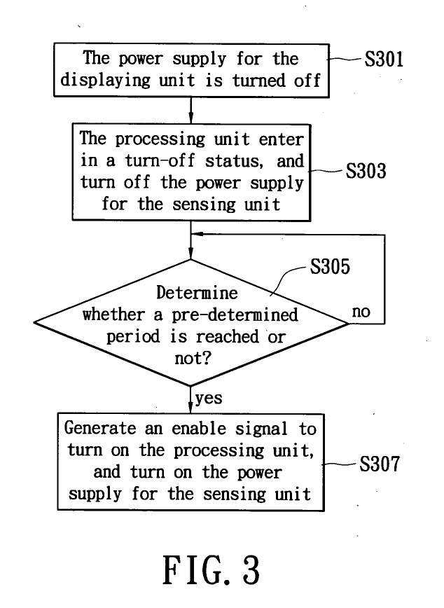

Reference is made to FIG. 3, which shows a flow chart of the digital photo frame with a power saving function operated in a power saving mode of the present invention. The power saving mode in FIG. 2 step S211 is illustrated by FIG. 3 here in detail. As shown in FIG. 2, after the power saving mode is determined, the power supply for the displaying unit 13 is turned off (S301). In one embodiment, the power supply for the displaying unit 13 is turned off, but processor unit 14 and sensing unit 12 are still on, and the sensing unit 12 can continuously detects the environmental status to determine whether the sensing unit 12 generates the sensing unit or not.

However, in order to save more power, in the second embodiment after step S301, the processing unit 14 enters into a turn-off status and the power supply for the sensing unit 12 is also turned off (S303). Next, the time-counting unit 11 is used for determining whether a pre-determined period is reached or not (S305). If the result of step S305 is yes, this means that the time-counting unit 11 outputs an enable signal to the processing unit 14 to turn on the processing unit 14 and supply the power to the sensing unit 12 (S307). Therefore, even though the sensing unit 12 is turned off, the sensing unit 12 still can perform the sensing operation via utilizing the enable signal generated by the time-counting unit 11 per pre-determined period (a shorter period, such as 2 seconds). If the result of step S305 is no, the step S305 is repeated to continuously execute until the pre-determined period is reached.

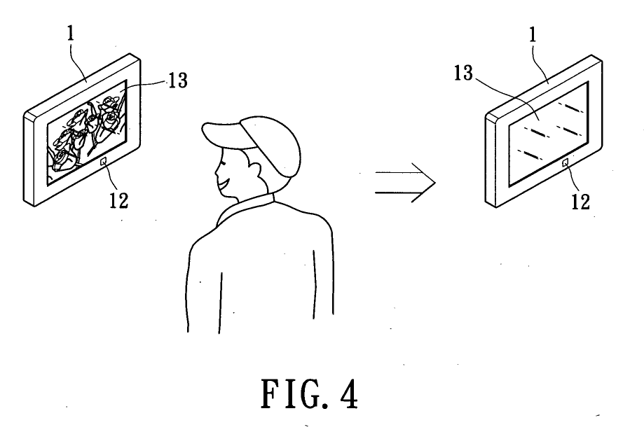

Reference is made to FIG. 4, which shows a schematic diagram of an application embodiment of the digital photo frame with a power saving function of the present invention. This embodiment illustrates the real operation status of the digital photo frame 1. At the left side of FIG. 4, the sensing unit 12 of the digital photo frame 1 detects that someone is around the digital photo frame 1, so that the digital photo frame 1 is operated in the normal operation mode to display the image data via the displaying unit 13. When the sensing unit 12 does not detect that anyone is around the digital photo frame 1 within the pre-determined period, the sensing unit 12 generates the sensing signal so that the digital photo frame 1 enters into the power saving mode and does not display image data on the displaying unit 13.

The digital photo frame of the present invention has a sensing unit for sensing the environmental status of the digital photo frame to determine whether someone is around the digital photo frame. When someone is near to the digital photo frame, the digital photo frame is normally operated to display the photos. When nobody is near to the digital photo frame, the digital photo frame enters the power-saving mode. Thereby, the digital photo frame has the power saving function, without modifying the complex power circuit or using power-saving elements.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A digital photo frame with a power saving function, comprising:
a time-counting unit for generating a time-counting signal;
a sensing unit for sensing an environmental status to generate a sensing signal;
a displaying unit for displaying image data; and
a processing unit for controlling the sensing unit to perform a sensing operation and controlling the displaying unit to display the image data, wherein the processing unit uses a power control unit to control a power supply according to the time-counting signal and the sensing signal so that the digital photo frame operates in a normal operation mode;
wherein, after the processing unit does not receive the sensing signal within a pre-determined period counted by the time-counting signal, the processing unit controls the power supply so that the digital photo frame is operated in a power saving mode.

2. The digital photo frame with a power saving function as claimed in claim 1, wherein the sensing unit is an IR sensor for checking the environmental status to generate a triggering signal to output the sensing signal.

3. The digital photo frame with a power saving function as claimed in claim 1, wherein the sensing unit is an image sensor for obtaining an image signal of the environmental status.

4. The digital photo frame with a power saving function as claimed in claim 3, wherein the sensing unit further executes an image calculation algorithm to calculate the image signal, and outputs the sensing signal when the image signal is a human body signal.

5. The digital photo frame with a power saving function as claimed in claim 1, wherein the power control unit is built-in with the processing unit or is externally connected to the processing unit.

6. The digital photo frame with a power saving function as claimed in claim 1, wherein the power saving mode is that of the processing unit turning off the power supply for the displaying unit, but with the processing unit and the sensor unit still on.

7. The digital photo frame with a power saving function as claimed in claim 6, wherein the power saving mode further includes that the processing unit enters into a turn-off status, and the power supply for the sensing unit is also turned off.

8. The digital photo frame with a power saving function as claimed in claim 7, wherein the time-counting unit generates an enable signal to the processing unit per a predetermined period to turn on the processing unit, and the power supply for the sensing unit is also turned on.

9. The digital photo frame with a power saving function as claimed in claim 1, further comprising:
a system interface unit connected with the processing unit for transmitting signals with an application system;
a storage unit for storing the image data and accessed by the processing unit; and
a power interface for receiving a household power, then converting and providing the household power to the power supply unit.

10. The digital photo frame with a power saving function as claimed in claim 9, wherein the storage unit is a non-volatile memory and/or memory card.

11. A power saving method for a digital photo frame, comprising:
(a) resetting a time-counting signal and counting the time, after the digital photo frame is turned on;
(b) providing a sensing unit to detect an environmental status; and
(c) controlling a power supply so that the digital photo frame enters in a power saving mode, when the sensing unit does not generate a sensing signal within a pre-determined period counted by the time-counting signal;
wherein, by repeating the step (b) and the step (c) until the sensing signal is generated in the step (b), the power supply is controlled so that the digital photo frame enters in a normal operation mode.

12. The power saving method for a digital photo frame as claimed in claim 11, wherein the sensing unit is an IR sensor for checking the environmental status to generate a triggering signal to output the sensing signal.

13. The power saving method for a digital photo frame as claimed in claim 11, wherein the sensing unit is an image sensor for obtaining an image signal of the environmental status.

14. The power saving method for a digital photo frame as claimed in claim 13, wherein the sensing unit further executes an image calculation algorithm to calculate the image signal, and outputs the sensing signal when the image signal is a human body signal.

15. The power saving method for a digital photo frame as claimed in claim 11, wherein a method for the power saving mode is that of the power supply for a displaying unit of the digital photo frame is turned off, but the processing unit and the sensing unit still on.

16. The power saving method for a digital photo frame as claimed in claim 15, wherein the method for the power saving mode further comprising:
making a processing unit of the digital photo frame enter into a turn-off status, and turning off the power supply for the sensing unit of the digital photo frame;
generating an enable signal per a pre-determined period to turn on the processing unit;
thereby, the power supply for the sensing unit is turned on via turning on the processing unit.
